(19) United States
(12) Patent Application Publication
(10) Pub. No.: US 2011/0029270 A1
(43) Pub. Date: Feb. 3, 2011

(54) DEVICE AND METHOD FOR CALIBRATING SWIVEL ASSEMBLIES, PARTICULARLY ON CUTTING MACHINES

(75) Inventor: Joerg Mueglitz, Meerane (DE)

Correspondence Address: SUGHRUE MION, PLLC, 2100 PENNSYLVANIA AVENUE, N.W., SUITE 800, WASHINGTON, DC, 20037, US

(73) Assignee: ESAB CUTTING SYSTEMS GMBH, karben (DE)

(21) Appl. No.: 12/600,202

(22) PCT Filed: Apr. 30, 2008
(86) PCT No.: PCT/DE2008/000752

§ 371 Date: Oct. 22, 2010

(30) Foreign Application Priority Data
May 16, 2007 (DE) 10 2007 023 585.4

(51) Int. Cl. G01D 18/00

(52) U.S. Cl. 702/105

(57) ABSTRACT

A device and method for calibrating swivel assemblies (21), particularly on cutting machines. Calibration of a tool on the machines mentioned above, portal robots, and the like, to the so-called Tool Center point (TCP) is done by a single movable measuring tip on the device, which has a direct operational connection of the tool, and a soft-ware-controlled measuring method for recording and repeatability of initial positions of a tool to be optimally adjusted. Determination of the TCP can be necessary after maintenance and repair work or after collisions on a machine tool or cutting machine. The device for calibrating swivel assemblies (21) includes a combination, as viewed from the frame (1), of three members, a first member (3), a second member (4), and a third member (5), displaceably connected among each other, with no play, to the frame (1) with no backlash by sliding joints (12, 13, 14) in all three axes of a Cartesian coordinate system. No mechanical reference position is present on any axis, and the third member (5) is connected to the frame (1) by the sliding joint (14), the second member (4) to the third member (5) by the sliding joining (13), and the first member (3) to the second member (4) by the sliding joint (12). The members (3, 4, 5) are monolithic, such that each member is made of a single component not formed by joining individual components. A holder (3b) is present on the first member (3), furthest from the frame, for connecting a measuring adapter (16) in a non-positive manner opposite the direction of gravity, and in a positive manner in a plane orthogonal thereto, rotary measuring sensors (6, 7, 8) are associated with the first, second, and third members (3, 4, 5) and determining the relative motions thereof to the neighboring members (4, 5) and/or the frame via the measuring pinions (9, 10, 11). Measuring toothed racks are present on each member (3, 4, 5), the measured values of which are used in a conversion component (2) and an online connection is provided between the conversion component (2) and a computer (24) via a data line (23).

The invention relates to a device and method for calibrating swivel assemblies, particularly on cutting machines.

Swivel assemblies are apparatuses which, with two or three numerically controlled drives, change the orientation of a tool, that is, they can rotate it around a point in several axes. They are part of numerically controlled machines or of industrial robots, are influenced in their movement behavior by a computer-based control and used in different areas of technology.

The reference point of the swivel movement is the so-called Tool Center Point (TCP). All rotational axes have to pass through this point, and the tool reference point, i.e. the center point of a spherical cutter, for example, has to be located exactly in this point.

A special type which has gained acceptance particularly in welding and cutting technology are swivel assemblies referred to as “TCP-fixed” or “kinematically decoupled”, in which swiveling of the tool around the TCP is enabled by an evident design, e.g. using coupler mechanisms or curved guides.

When manufacturing swivel assemblies, when using them in practice in the production process, e.g. after collisions or after maintenance and repair work, it is required to redetermine the location of the TCP in a machine coordinate system. The rough position of the TCP is known in this case. The exact position may deviate therefrom on the scale of several millimeters.

This deviation has to be determined and proper action of the operator or service technician derived therefrom. The obtained measured values serve for mechanically changing geometrical parameters (e.g. common perpendiculars between axes, angles between axes, etc.) on the swivel assembly. For this purpose, the swivel assembly has corresponding devices, such as adjusting screws and setting devices.

The accurate calibration of a swivel assembly has a crucial influence on the quality of the technological operations performed with its help, e.g. welding, milling, laser cutting.

The calibration process, on the other hand, is very complex and requires great expertise by the worker entrusted with this task, since the number of adjusting and setting devices is large (approximately 5 to 10), and there is no explicit functional relationship between these setting devices and the accuracy at the TCP, i.e. manipulations usually will have to be made on more than one setting device.

Only on industrial robots delivered as a complete set this process is supported by a special software and special instructions, while particularly on portal robots composed of modules, calibration so far has been a largely empirical, time-consuming activity which can only be performed by specially trained workers.

From a state of the art perspective, calibration of kinematically decoupled swivel assemblies, e.g. in welding and cutting technology, is frequently carried out using very insufficient means. Particularly when calibration under production conditions becomes necessary, often simply a fixed tip is used. For this purpose, the tool is oriented with reference to this tip by means of the axes of movement of the machine, then the movement of the tool around the point is evaluated visually, and calibration actions are derived therefrom. This is subjective, time-consuming and requires great skills on the side of the worker or service technician.

To some extent simple gages are used for initial startup in the production plant.

In U.S. Pat. No. 5,639,204 a device is described which, in a manner of indexing, closes the open kinematic chain of an industrial robot, thus enabling quick replacement of a robot drive motor, e.g. in the case of service works.

Also, gages are known which are mounted on the swivel assembly on fixing points provided particularly for this purpose and which describe the ideal location of the TCP in the swivel assembly coordinate system by means of a point-shaped tip (instructions for use BevelMaster, ESAB Cutting Systems, 2003). In the case of service works or during initial startup the tool has to be oriented with reference to this tip.

These gages help to accelerate the adjustment of the swivel assembly. Their geometry is based on theoretical assumptions, i.e. manufacturing deviations on the one hand and geometrical changes in the swivel assembly as a result of collisions on the other hand cannot be detected with gages of this type. Their mounting on the swivel assembly is time-consuming and requires expertise. The gages themselves are bulky, just as any gage they require special treatment and maintenance, and they are not, or only to a very limited extent, suitable for use under production conditions.

Apparatuses are known using dial indicators, such as the ones described in DE 3822597A1. While the gages described above make only a qualitative and subjective statement regarding the location of the TCP, apparatuses based on dial indicators allow also quantitative statements to be made.

To infer the location of the TCP from the readings of the dial indicators and to derive calibration actions therefrom requires even more expertise by the worker than with the gages described above.

In DE 10203002 B4 a device is described which, by means of dial indicators and the principle of coordinate measuring technology, which in itself has been known for a long time, measures points on manufacturing apparatuses, e.g. for manufacturing vehicle body parts, which are placed within the working envelope of the robot and whose theoretical location is known.

This is to exactly determine the real location of a manufacturing apparatus and to generate offset values for the robot programs created off-line.

This is a device installed largely fixedly on the manufacturing apparatus, whose location in the manufacturing apparatus coordinate system has to be known. Therefore, the device has a fit bore which in turn requires a centering pin on the reference part, i.e. the apparatus. Mounting has to be carried out in a very precise manner, since mounting tolerances have a direct influence on calibration accuracy.

At least three measuring points are required to determine the location of a manufacturing apparatus. Therefore, as described in DE 10203002 B4, at least three such devices have to be installed on a manufacturing apparatus to be calibrated, or the device has to be brought to its location in a time-consuming procedure.

Moreover, the device has to have a precisely defined and repeatably self-adjustable “zero” position. Its tolerances also have a direct influence on calibration accuracy.

For each further manufacturing apparatus additional devices are necessary. Each measured value, i.e. at least 9 parameters per measurement, has to be transferred to the robot control, either automatically or manually, and be processed there. Moreover, certain measuring equipment is required also on the robot, which raises the question whether, from a technical and economic perspective, it is not the better solution to install the device on the robot and move to points of the manufacturing apparatus, such as during set-up of a workpiece in a milling machine using a measuring probe.

For measuring industrial robots a number of systems are known which increase their accuracy of pose. All of these systems work on a non-contact optical basis. One system (brochure available from Wiest AG, Königsbrunner Str. 5, 86507 Oberottmarshausen) is based on a measuring ball which is mounted on a robot tool flange and moved by the robot in a fixed measuring sensor. Within the measuring sensor there are five laser triangulation sensors which, with the aid of special software, determine the center of the ball. A comparable system (brochure available from TECONSULT, Kaltenhofe Hinterdeich 17, 20539 Hamburg) operates inversely in that the measuring ball is arranged stationarily, and a special tool equipped with cameras is attached to the robot flange.

A third system as proposed in EP 0963816A2 operates with stationary cameras which determine the location of a test body in space. Unlike the first two solutions, which have only small measuring ranges on the scale of several centimeters, this system is adapted to measure the movement of the test body within a significant part of the working envelope of the robot.

Apparatuses which operate using light barriers may be more cost-effective. One such apparatus having only a single light barrier is described in U.S. Pat. No. 5,907,229. The position of the robot is sought in which the robot hits the light barrier with a tool of known geometry, thus interrupting the beam. With a sufficiently large number of attempts and if the target geometry of the robot is known, offset values can be obtained in this manner which improve the accuracy of the robot. WO 002003059580A2 and U.S. Pat. No. 5,177,563 describe similar apparatuses which use several light barriers simultaneously.

The optical measurement principles of all of these systems require special environmental conditions with regard to lighting and dust exposure. Extreme dust loads in the air will probably impede their use, if not render it impossible. What is inherent to all of the four technical solutions mentioned above is that they are tailor-made for one or more special robot types. They are complex, and, due to the measurement principles used, they are expensive. Their high complexity, also with regard to software, is necessary in order to be able to determine the large number of arbitrary parameters for a general model of a six-axes industrial robot.

For portal robots composed of modules the calibration task is easier in that the positional axes, i.e. the ones responsible for the position of the tool in space, have an adequate accuracy and that an explicit, linear relationship exists between the movement of the linear axes and the movement of the TCP. The influence of the positional axes on calibration can thus be neglected in a first approximation, and calibration is limited to the swivel assembly, i.e. the device which is responsible for orienting the tool around the TCP.

The procedure of calibration on TCP-fixed swivel assemblies differs significantly from the one on industrial robots in that it has to be carried out not by parameterization of characteristic values within a software, but by changing mechanical parameters with the aid of setting devices.

From the state of the art described above it becomes clear that only with a disproportionate amount of effort, complicated measuring systems, and a great deal of experience on the side of the set-up men of machine tools or cutting machines does it become possible to approximately determine the location of the tool center point, e.g. the center point of the spherical cutter or the wire tip of a welding torch, relative to a preset Tool Center Point.

Therefore, a solution has to be sought which fulfills the following criteria:
to perform the determination of the TCP location quickly, accurately, and reproducibly using a compact and lightweight device which can be handled under rough manufacturing conditions (dust, heat) in combination with a special method;
to carry out the determination of the location by a largely automatic process and to enable its handling by a layperson;
to filter and assess the data obtained by the device by means of a computer-assisted method such that for a swivel assembly mechanism of known structure, e.g. the device described in PS 1020005041482, the computer yields precisely defined instructions in the form of “ . . . turn adjusting screw no. 2 by 0.7 turns in the clockwise direction . . . ”, which also enables untrained users to carry out an adjustment.

The object of the invention is thus to provide a device particularly for swivel assemblies and a method suitable for their use, which can be applied for the manufacture and startup of the swivel assembly as well as in rough production environments after maintenance work or after a collision. The device is to be small, lightweight, cost-effective, but suitable for use in rough environmental conditions with regard to temperature and pollution.

The device and method are to be able to be used in a machine-independent and self-contained manner.

The object of the invention is further to determine quickly, accurately, and reproducibly the location of a tool center point, e.g. the center point of a spherical cutter or the wire tip of a welding torch, relative to a Tool Center Point located fixedly in the swivel assembly. This determination of the location is to be performed by a largely automatic process which is to be able to be handled by a layperson.

It is also the object of the invention to computer-generate, based on the determination of the location, instructions to set, with the aid of the adjusting and setting devices present on the swivel assembly, the TCP of the tool such that the sum of the deviations of location is below a given minimum.

Moreover, it is the object of the invention to propose a device which can be arranged in the machine coordinate system arbitrarily, “by the eye”, so to speak, and which does not need a fixed absolute position relative to the machine nor in itself.

The object of the invention is achieved as follows, reference being made to patent claims 1, 5, and 6 with regard to the basic idea of the invention. The further realization of the invention becomes apparent from patent claims 2 to 4 and 7 and 8.

How the object of the invention is achieved will now be explained in greater detail.

The device of the invention comprises a serial arrangement, as viewed from the frame, of members being connected by joints. It is explicitly noted that the joints can be designed both positively bonded and material-bonded.

On the member furthest from the frame a holder is present for connecting a measuring adapter in a non-positive manner opposite the direction of gravity, and in a positive manner in a plane orthogonal thereto. The measuring adapter comprises a ball located in the TCP of the tool installed in the swivel assembly. For this purpose, instead of the tool, a special calibrating tool has to be included in the swivel assembly, or the head of the tool has to be replaced accordingly. In a cutting torch, for example, an accordingly designed nozzle cap is inserted in the torch manually or automatically.

The number of members of the device is selected such that, depending on the configuration and arrangement of the swivel assembly, a positive movement occurs and the degree of freedom without connection between the device and the measuring adapter is more than 1.

A measuring system is arranged between each member. During a swivel movement of the swivel assembly and the tool attached thereto, the device connected thereto via the measuring adapter is moved, and each measuring system yields measuring data for a Cartesian measuring coordinate system without the need of a coordinate transformation.

At the beginning of the calibration cycle the device should be approximately in the central position. The device does not have an internal reference position.

In a second stage of configuration the special computer program serving for representation of the measuring data possesses “intrinsic intelligence” and guides the user of the program through the calibration cycle such that information can be obtained from the measuring data which enables the state of the swivel assembly to be evaluated. This occurs both in a qualitative manner, evaluating the exact calibration of the swivel assembly using simple Yes/No information and providing, in the decalibrated state, precise instructions for calibration. In this way, it is possible to assign the task of calibration also to non-experts.

In a third stage of configuration the calibrating device becomes part of the machine. The tool is equipped with the measuring adapter automatically by a replacement apparatus at defined intervals, e.g. at each beginning of a shift or a new order or after a collision. The machine moves the swivel assembly into the calibrating apparatus mounted fixedly in the machine coordinate system, and the calibration cycle is run through as described for configuration stage 2. The current state of the swivel assembly is saved in the machine.

To minimize the size, mass, and manufacturing costs, the device is constructed of a frame carrying members such that the individual members not fixed to the frame are made of a monolithic, non-divisible body manufactured in one piece by stereolithography. The swivel assembly is constructed such that extremely smooth running and practical freedom from play are ensured. Consequently, the movement of the TCP is mapped completely by the device via the measuring adapter, and there are no reactions on the swivel assembly by the device itself via the measuring adapter.

By means of a computer-based method, the measuring movements of the device of the invention are recorded, evaluated and, ultimately, the zero position of the TCP is established. This is done as follows:

By a computer-based arrangement, the current measuring data is read synchronously and in quick succession, saved, and represented graphically on a display in the form of a trajectory. Moreover, the computer-based arrangement possesses an intelligent program in that it analyzes the saved data, provides a qualitative statement regarding the state of the swivel assembly which is dependent on its respective application purpose (swivel assembly is adjusted/swivel assembly is deadjusted), and, in the latter case, provides instructions for achieving an adjusted state. The smaller the absolute values of the measuring data are, the more accurately the swivel assembly is calibrated.

The device can be used in different ways. First of all, it is designed such that it cooperates with any computer via a standardized interface such that the measuring data provided by the device are represented graphically on the computer display and this graphic information allows a skilled operator, e.g. a service technician, to evaluate the state of the swivel assembly easily and quickly and to calibrate the swivel assembly. The machine starts a special NC program for this purpose which moves the swivel assembly in a precisely defined manner.

The invention will now be explained in more detail by means of a suitable exemplary embodiment.

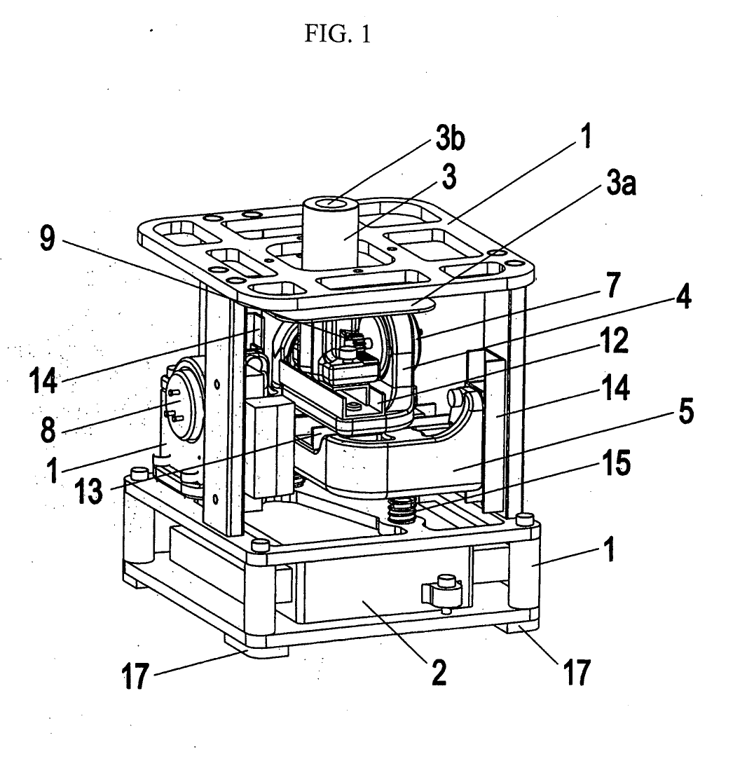

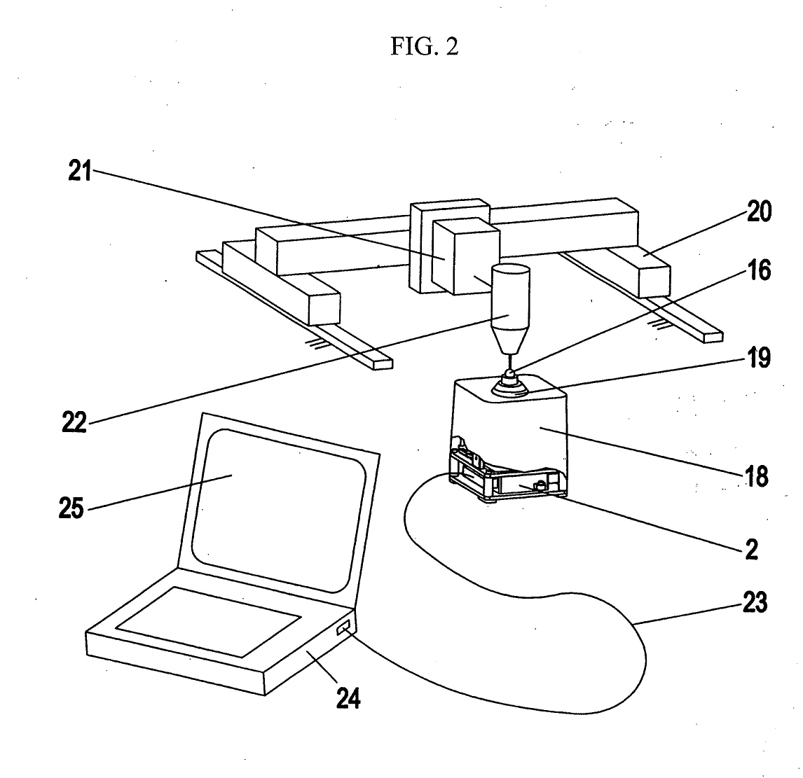

For this purpose reference will be made to FIGS. 1 and 2 in which:

FIG. 1 shows a simplified three-dimensional representation of the calibrating device;

FIG. 2 shows a schematic representation of the device used in combination with further components during calibration of a swivel assembly.

The reference numerals used in FIGS. 1 and 2 have the following meaning:
1 frame
2 electronic conversion component
3 first member
3a stop plate
3b holder
3c measuring toothed rack 1
4 second member
4a measuring toothed rack 2
5 third member
5a measuring toothed rack 3
6, 7, 8 measuring sensors
9, 10, 11 measuring pinions
12, 13, 14 sliding joints
15 compression spring
16 measuring adapter
17 feet
18 covering
19 bellow seal
20 portal machine
21 swivel assembly
22 tool
23 data line
24 computer
25 computer-graphical on-screen representation

The device of the invention comprises a serial arrangement, as viewed from the frame 1, of three members, the first member 3, the second member 4, and the third member 5, orthogonally displaceably connected among each other and to the frame 1 by the sliding joints 12, 13, and 14, the third member 5 being connected to the frame 1 by the sliding joint 14, the second member 4 to the third member 5 by the sliding joint 13, and the first member 3 to the second member 4f by the sliding joint 12. It is explicitly noted that the sliding joints 12, 13, and 14 can be designed both positively bonded and material-bonded.

A holder 3b is present on the first member 3, furthest from the frame, for connecting a measuring adapter 16 in a non-positive manner opposite the direction of gravity, and in a positive manner in a plane orthogonal thereto. The measuring adapter 16 comprises a ball located in the TCP of the tool installed in the swivel assembly. For this purpose, instead of the tool (e.g. the welding torch, the cutting torch, the milling machine), the measuring adapter has to be included in the swivel assembly. In a cutting torch, for example, an accordingly designed nozzle cap which then represents the measuring adapter 16, is inserted in the torch manually or automatically.

The number of members of the apparatus is selected such that a positive movement occurs during the calibration cycle and the degree of freedom without connection between the calibration apparatus and the measuring adapter 16 is more than 1.

Measuring sensors 6, 7, 8 are arranged between each member. During a swivel movement of the swivel assembly and the tool attached thereto, the calibration apparatus connected thereto via the measuring adapter 16 is moved, and each measuring sensor 6, 7, 8 yields measuring data in a Cartesian measuring coordinate system without the need of a coordinate transformation.

To minimize the size, mass, and manufacturing costs, and to increase robustness, the device is constructed of a stable frame 1, which carries members 3, 4, 5 manufactured by Rapid Prototyping directly from the CAD without any machining, such that the individual members 3, 4, 5 each are made of only one single, monolithic component.

The calibration apparatus is positioned anywhere within the working envelope of the portal machine 20 by means of feet 17. The calibration apparatus shall be fixed immovably against the forces occurring during calibration, which are very slight, however; therefore, the feet 17 are preferably designed magnetically or as suction feet. Manual fixation of the calibration apparatus within the working envelope of the machine and in its orientation toward the axial directions of the portal machine 20 “by the eye” is completely sufficient.

By means of the Cartesian movement axes of the portal machine 20 and after installation of the measuring adapter 16 in the tool 22, the connection between the holding device 3b and the measuring adapter 16 and thus the positive movement of the calibration apparatus is established. The operator only has to make sure that the calibration apparatus is approximately in the central position and that the first member 3, furthest from the frame, is at a distance of at least several millimeters from the final position predetermined by the stop plate 3a. The calibration apparatus is now ready to operate.

By a program-controlled movement of the swivel assembly 21 the calibration device will, by the positive movement established via the measuring adapter 16 and the holding device 3b, move in the same manner as the TCP of the tool 22, and measuring data of the relative motions of the members 3, 4, and 5 will be obtained with chronological synchronism and in quick succession.

The current measuring data are converted by an electronic conversion component 2 into a machine-readable, standardized signal and transferred via a data line 23 to a personal computer 24. Here, the data are read, saved, and represented computer-graphically on a display in the form of trajectories 25.

With the aid of this graphic representation, which not only describes the current state of the swivel assembly 21, but also, on-line, i.e. without any perceptible time delay, maps mechanical changes in the swivel assembly 21, it is possible in a quick and easy manner for a skilled user to perform a calibration of the swivel assembly 21. Generally, the smaller the absolute values of the measuring data are, the more accurately the swivel assembly 21 is calibrated.

The measuring data are saved and archived and represent a reproducible, objective image of the current state of the swivel assembly 21.

The movement of the tool tip on TCP-fixed swivel assemblies, irrespective of their kinematic structure and design, is composed of two circular arcs which are located in two planes usually standing orthogonally on each other. Their superposition gives rise to a torus. By means of approximation the parameters of these geometrical objects can be determined. The parameters are a measure of the deviation of the location of the TCP from its ideal position.

The special computer program possesses “intrinsic intelligence” in that it analyzes saved data in the manner described above, provides a qualitative statement regarding the state of the swivel assembly 21 which is dependent on its respective application purpose (“swivel assembly is adjusted/swivel assembly is deadjusted”), and, in the latter case, provides instructions for achieving an adjusted state. For this purpose, the program guides the user through the calibration cycle by means of detailed instructions derived by the measuring data in the form of: “Please turn screw 4 by 1.5 turns in the counterclockwise direction, fix the screw by a locknut, and start a new measuring cycle,” and thus enables even untrained workers, e.g. the machine operators, to be entrusted with the task of calibration. Tasks reserved so far for qualified service technicians can now be performed by normal skilled workers.

1. A device for calibrating a swivel assembly, comprising: a combination, as viewed from the frame (1), of three members, a first member (3), a second member (4), and a third member (5), displaceably connected among each other, practically free from play and force, to the frame (1) by sliding joints (12, 13, 14)—along three axes standing orthogonally on each other—, no mechanical reference position being present on any axis, and the third member (5) being connected to the frame (1) by the sliding joint (14), the second member (4) to the third member (5) by the sliding joint (13), and the first member (3) to the second member (4) by the sliding joint (12), the members (3, 4, 5) being monolithic, such that each member is made of a single component not formed by joining individual components, and a holder (3b) being present on the first member (3), furthest from the frame, for connecting a measuring adapter (16) in a non-positive manner opposite the direction of gravity, and in a positive manner in a plane orthogonal thereto, rotary measuring sensors (6, 7, 8) being associated with the first, second, and third members (3, 4, 5) and determining the relative motion thereof to at least one of the neighboring members (4, 5) and the frame (1) via the measuring pinions (9, 10, 11) and the measuring toothed racks 1, 2, 3 (3c, 4a, 5a) present on each member (3, 4, 5), the measured values of which are used in a conversion component (2) and an online connection being present between the conversion component (2) and a computer (24) via a data line (23).

2. A device for calibrating swivel assemblies (21) according to claim 1, wherein the measuring adapter (16) comprises a ball, the latter being located in the TCP of the tool installed in the swivel assembly (21).

3. A device according to claim 1, wherein the device is advanced to the tool head of the respective swivel assembly (21) in a mobile, machine-independent manner and from the outside and wherein its secure place of installation is ensured by feet (17) which either include permanent magnets or are designed as suction feet.

4. A device according to claim 1, wherein a dust-tight, shockproof, and temperature-stable encapsulation of the device is provided by a covering (18) and a bellow seal (19).

5. A device for calibrating a swivel assembly, the calibrating device being present as an integral part of a machine tool.

6. A method for calibrating a swivel assembly, for the purpose of using the device according to claim 1, wherein measuring data resulting from the relative motions of the members (3, 4, 5) and the frame (1) are obtained by measuring sensors (6, 7, 8) with chronological synchronism and in quick succession, processed in the electronic conversion component (2) into a standardized data signal and fed to a computer (24) associated via the data line (23) for further processing and saving, on whose monitor a computer-graphical screen representation (25) is generated on-line, the reference point of which is the position of the device at the beginning of the current measurement.

7. A method according to claim 6, wherein the computer (24) maps the progress of calibration on-line computer-graphically.

8. A method according to claim 6, wherein the measuring data continually supplied to the computer (24) via the data line (23) are filtered and analyzed by it in a quickly repeating cycle, form the basis of the calculation of the location of the TCP performed by the computer, and, based on the location of the TCP relative to the measuring data on the one hand and the type of the wrist joint on the other hand, the computer (24), using detailed instructions regarding the setting device to be actuated, the absolute value, and the sense of direction of the setting parameter, optionally by voice output, text instructions, or computer animations, guides the user through the calibration process up to the point at which the sum of the calculated deviations of location of the TCP fall below a defined limit value.

9. A device according to claim 1, wherein the swivel assembly is provided on a cutting machine.

10. A device according to claim 5, wherein the swivel assembly is provided on a cutting machine.

11. A method according to claim 6, wherein the swivel assembly is provided on a cutting machine.
